(19) United States
(12) Patent Application Publication
(10) Pub. No.: US 2006/0200655 A1
(43) Pub. Date: Sep. 7, 2006

(54) Forward looking branch target address caching

(76) Inventors: Rodney Wayne Smith, Raleigh, NC (US); Brian Michael Stempel, Raleigh, NC (US); James Norris Dieffenderfer, Apex, NC (US); Jeffrey Todd Bridges, Raleigh, NC (US); Thomas Andrew Sartorius, Raleigh, NC (US)

Correspondence Address: QUALCOMM INCORPORATED, 5775 MOREHOUSE DR., SAN DIEGO, CA, 92121, US

(21) Appl. No.: 11/073,283

(22) Filed: Mar. 4, 2005

(51) Int. Cl. G06F 9/00

(52) U.S. Cl. 712/238

(57) ABSTRACT

A pipelined processor comprises an instruction cache (iCache), a branch target address cache (BTAC), and processing stages, including a stage to fetch from the iCache and the BTAC. To compensate for the number of cycles needed to fetch a branch target address from the BTAC, the fetch from the BTAC leads the fetch of a branch instruction from the iCache by an amount related to the cycles needed to fetch from the BTAC. Disclosed examples either decrement a write address of the BTAC or increment a fetch address of the BTAC, by an amount essentially corresponding to one less than the cycles needed for a BTAC fetch.

### TECHNICAL FIELD

The teachings in this disclosure relate to techniques for caching branch instruction target addresses, particularly with advanced fetching of the cached target address in relation to fetching of a cached branch instruction, and to processors using such techniques.

### BACKGROUND

Modern microprocessors and other programmable processor circuits often rely on a pipeline processing architecture, to improve execution speed. A pipelined processor includes multiple processing stages for sequentially processing each instruction as it moves through the pipeline. While one stage is processing an instruction, other stages along the pipeline are concurrently processing other instructions.

Each stage of a pipeline performs a different function necessary in the overall processing of each program instruction. Although the order and/or functions may vary slightly, a typical simple pipeline includes an instruction Fetch stage, an instruction Decode stage, a memory access or Readout stage, an instruction Execute stage and a result Write-back stage. More advanced processor designs break some or all of these stages down into several separate stages for performing sub-portions of these functions. Super scalar designs break the functions down further and/or provide duplicate functions, to perform operations in parallel pipelines of similar depth.

In operation, the instruction Fetch stage fetches the next instruction in the currently executing program. Often, the next instruction is that at the next sequential memory address location. Processing of some instructions may result in a branch operation, in which case the next instruction is at a non-sequential target address produced by decoding and a decision during execution to take the target branch for subsequent processing.

There are two common classes of branch instructions, conditional and unconditional. A processor decides whether or not to take a conditional branch instruction, depending upon whether or not the condition(s) of the branch are satisfied at the time of processing the instruction. The processor takes an unconditional branch every time the processor executes the instruction. The instruction to be processed next after a branch instruction, that is to say the target address of the instruction, is determined by a calculation based on the particular branch instruction. Particularly for a conditional branch, the target address of the branch result may not be definitively known until the processor determines that the branch condition is satisfied.

For a given fetch operation, the Fetch stage initially attempts to fetch the addressed instruction from an instruction cache (iCache). If the instruction is not yet contained in the iCache, the Fetch stage fetches it from a higher level memory, such as a level 2 instruction cache or the main memory of the system. If fetched from higher level memory, the instruction is loaded into the iCache.

The Fetch stage provides each fetched instruction to the instruction Decode stage. Logic of the instruction Decode stage decodes the instruction bytes received and supplies the result to the next stage of the pipeline, i.e. to the Readout in a simple scalar pipeline. If the instruction is a branch instruction, part of the decode processing may involve calculation of the branch target address. Logic of the Readout stage accesses memory or other resources to obtain operand data for processing in accord with the instruction. The instruction and operand data are passed to the Execute stage, which executes the particular instruction on the retrieved data and produces a result. A typical execution stage may implement an arithmetic logic unit (ALU). The fifth stage writes the results of execution back to a register or to memory.

In such operations, the Execute stage will, from time to time, receive and process one of the branch instructions. When processing a branch instruction, the logic of the Execute stage determines if the branch is to be taken, e.g. if conditions for a conditional branch operation are satisfied. If taken, part of the result is a target address (often calculated by the instruction Decode stage), which the Fetch stage will utilize as the instruction address for fetching the next instruction for processing through the pipeline. To enhance performance, the target address may be cached in a manner analogous to the cache processing of the instructions. For example, for a branch taken, the calculated target address may be stored in a branch target address cache (BTAC), typically, in association with the address of the branch instruction that generated the target address.

For each fetch operation, the Fetch stage uses a new instruction address and attempts to access both the iCache and the BTAC with that fetch address. Assuming that the instruction has been loaded into the iCache, the iCache will supply the addressed instruction to the Fetch stage logic. If the address corresponds to a branch instruction, and the branch was previously taken, there will be a ‘hit’ in the BTAC, in that the BTAC will have a target address stored for that instruction address, and the BTAC will supply the cached target address to the Fetch logic. If the current fetch address does not correspond to a branch instruction or the branch has not yet been taken, there is no hit as the BTAC will not have a target address stored for the current fetch instruction address.

When there is a BTAC hit, the logic may predict whether or not the branch is likely to be taken again. If so, the target address is applied to the fetch logic for use as the next address (instead of the next sequential address). Hence, the next fetch operation following the fetch of the branch instruction uses the cached target address retrieved from the BTAC to fetch the instruction corresponding to the target address.

As processor speeds increase, a given stage has less time to perform its function. To maintain or further improve performance, each stage is sub-divided. Each new stage performs less work during a given cycle, but there are more stages operating concurrently at the higher clock rate. As memory and processors have improved, the length of the instructions and the length of the instruction addresses increase. In many pipeline processors, the fetch operation is broken down and distributed among two or more stages, and fetching the instructions from the iCache and the target addresses from the BTAC takes two or more processing cycles. As a result, it may take a number of cycles to determine if there is a hit in the BTAC fetch, during which stages performing iCache fetches have moved on and begun fetch operations on one or more subsequent iCache fetches. In a multi-cycle fetch operation, upon detection of the BTAC hit, the subsequent fetch processing must be discarded, as the next fetch operation should utilize the address identified in the BTAC. The discard causes delays and reduces the benefit of the BTAC caching. As the number of cycles required for a BTAC fetch increases, the degradation in performance increases. Hence a need exists for further improvements in branch target address caching techniques, particularly as they might help to reduce or eliminate unnecessary processing of iCache stages in the event of a BTAC hit.

### SUMMARY

As should be apparent from the background discussion, the normal operation uses the same address to concurrently access both the instruction cache and the branch target address cache (BTAC) during an instruction fetch. To further improve performance, the BTAC fetch operation looks forward, that is to say, fetches ahead of the instruction fetch from the instruction cache. In disclosed examples, the BTAC fetch looks forward of the iCache fetch by using a future instruction address or because the target was written to the BTAC with an earlier address value. Aspects of these teachings relate to both methods and processors.

A first such method, for fetching instructions for use in a pipeline processor, involves fetching instructions from an instruction cache and concurrently accessing a branch target address cache (BTAC) during each fetching of an instruction. The BTAC access determines if the BTAC stores a branch target address. Each access of the BTAC takes at least two processing cycles. The method also involves offsetting the accessing operations by a predetermined amount relative to the fetching operations to begin an access of the BTAC in relation to a branch instruction at least one cycle before initiating a fetch of the branch instruction.

In the various examples discussed in detail below, the offset is sufficient to fetch a branch target address corresponding to the branch instruction from the BTAC for use in a subsequent instruction fetch that begins in a processing cycle immediately following the processing cycle which began the fetching of the branch instruction. Specific examples of this method provide incrementing of the address for the BTAC fetch as part of the fetching operations or provide a decrement of the address for writing the branch target to the BTAC. The later option need not be implemented in the fetching operation itself but may be implemented in or responsive to processing in one or more of the later stages of pipeline processing.

The amount of the offsetting is sufficient to enable fetching of a branch target address corresponding to the branch instruction from the BTAC, for use in a subsequent instruction fetch that begins in a processing cycle immediately following a cycle which began the fetching of the branch instruction. In the examples, the offset amount comprises an address difference between the instruction cache and the BTAC equal to one less than the number of cycles required for each access of the BTAC.

Another method of fetching instructions for use in a pipeline processor entails starting a fetch of a first instruction from an instruction cache and concurrently initiating a fetch in a BTAC. The BTAC access is for fetching a target address corresponding to a branch instruction which follows the first instruction. This method also involves starting a fetch of the branch instruction from the instruction cache. Following start of the fetch of the branch instruction, the target address corresponding the branch instruction is used to initiate a fetch of a target instruction from the instruction cache.

A processor in accord with the present teachings comprises an instruction cache, a branch target address cache, and processing stages. One of the stored instructions is a branch instruction, and the branch target address cache stores a branch target address corresponding to that instruction. The processing stages include a fetch stage and at least one subsequent processing stage for performing one or more processing functions in accord with fetched instructions. The fetch stage fetches instructions from the instruction cache and fetches the branch target address from the branch target address cache. The processor also includes offset logic. The logic provides an offset of the fetching from the branch target address cache ahead of the fetching of the instructions from the instruction cache, by an amount related to the number of processing cycles required to complete each fetching from the branch target address cache.

In the examples, the forward looking offset amount is one less than the number of processing cycles required to complete each fetching from the branch target address cache. The offset logic may be associated with the fetch stage, for example, to increment an instruction fetch address to allow the fetch stage to use a leading address to fetch from the branch target address cache. Alternatively, the offset logic may write branch targets into the branch target address cache using a decremented instruction address value.

The exemplary processors are pipeline processors often having five or more stages. The subsequent processing stages may include an instruction decode stage, a readout stage, and instruction execute stage and a result write-back stage. Of course, each of these stages may be broken down or pipelined. Also, the fetch stage may be pipelined so as to comprise multiple processing stages.

In one example, the address used for the BTAC fetch leads that used in the instruction cache fetch, by an offset intended to compensate for the delay in fetching from the BTAC in the case of a hit. If implemented during a fetch, this entails an increment in the fetch address. Alternatively, when writing to the caches, the BTAC write address may lead the address used for storage of the branch instruction in the instruction cache, by the appropriate offset amount. Since it is implemented on the write operation but is intended to cause a read or fetch before the corresponding instruction cache fetch, the write operation decrements the address used to write the target address into the BTAC.

Additional objects, advantages and novel features will be set forth in part in the description which follows, and in part will become apparent to those skilled in the art upon examination of the following and the accompanying drawings or may be learned by production or operation of the examples. The objects and advantages of the present teachings may be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a functional block diagram of a simple example of a pipeline processor, with a forward looking offset of fetching from a branch target address cache ahead of a corresponding fetch from an instruction cache.

FIG. 2 is a functional block diagram of a simple example of the fetch and decode stages of a pipeline processor, implementing a two-cycle (or two stage) fetch.

FIG. 3 is a table useful in explaining cycle timing in the fetch stage of FIG. 2, without an offset between a fetch from the instruction cache and a corresponding fetch from the branch target address cache.

FIG. 4 is a table useful in explaining cycle timing in the fetch stage of FIG. 2, with an offset between a fetch from the branch target address cache and a corresponding fetch from the instruction cache, where the offset is related to (e.g. one less than) the number of cycles or number of stages implementing the target address fetch.

FIG. 5 is a functional block diagram of a simple example of the fetch and decode stages of a pipeline processor, implementing a three-cycle (or three stage) fetch.

FIG. 6 is a table useful in explaining cycle timing in the fetch stage of FIG. 5, with an offset between a fetch from the branch target address cache and a corresponding fetch from the instruction cache, where the offset is related to (e.g. one less than) the number of cycles or number of stages implementing the target address fetch.

FIG. 7 is a partial block diagram and flow diagram, useful in understanding an example wherein the offset is implemented as an increment of the instruction fetch address.

FIG. 8 is a partial block diagram and flow diagram, useful in understanding an example wherein the offset is implemented as of an instruction address used in writing a target address to the branch target address cache.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

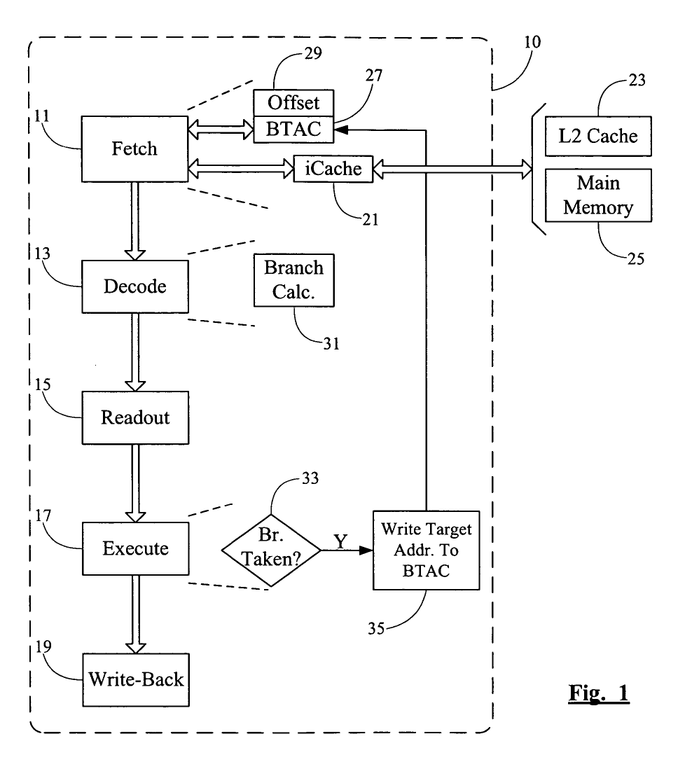

The various techniques disclosed herein relate to advantageous timing of a branch target address fetch ahead of a corresponding instruction fetch, particularly as such fetches are performed in pipeline type processing. Reference now is made in detail to the examples illustrated in the accompanying drawings and discussed below. FIG. 1 is a simplified block diagram of a pipeline processor 10. The simplified pipeline includes five stages.

The first stage of the pipeline in processor 10 is an instruction Fetch stage 11. The Fetch stage obtains instructions for processing by later stages. The Fetch stage 11 supplies each instruction to a Decode stage 13. Logic of the instruction Decode stage 13 decodes the instruction bytes received and supplies the result to the next stage of the pipeline. In the simple example, the next stage is a data access or Readout stage 15. Logic of the Readout stage 15 accesses memory or other resources (not shown) to obtain operand data for processing in accord with the instruction. The instruction and operand data are passed to the Execute stage 17, which executes the particular instruction on the retrieved data and produces a result. The fifth stage 19 writes the results back to a register and/or memory (not shown).

Pipelining of the processing architecture in this manner allows concurrent operation of the stages 11-19 on successive instructions. Modem implementations, particularly for high-performance applications, typically break these stages down into a number of sub-stages. Super-scalar designs utilize two or more pipelines of substantially the same depth operating concurrently in parallel. For ease of discussion, however, we will continue to relate the examples to a simple five-stage pipeline example as in processor 10.

The Fetch stage logic often will include or interface to an instruction cache (iCache) 21. When fetching an instruction identified by an address, the logic of the Fetch stage 11 will first look to the iCache 21 to retrieve the instruction. If the addressed instruction is not yet in the iCache, the logic of the Fetch stage 11 will fetch the instruction into the iCache 21 from other resources, such as a level two (L2) cache 23 or main memory 25. The instruction and address are stored in the iCache 21. The Fetch stage logic can then fetch the instruction from the iCache 21. The instruction will also be available in the iCache 21, if needed subsequently.

Execution of many instructions results in branches from a current location in a program sequence to another instruction, i.e. to an instruction stored at a different location in memory (and corresponding to a non-sequential address). Processing a branch instruction involves calculation of the branch to target address. To speed the fetch operations, the fetch stage logic often will include or interface to a branch target address cache (BTAC) 27, for caching target addresses in a manner analogous to the function of the iCache 21. In accord with the present teachings, the target address retrieved from the BTAC 27 is offset (at 29) from that of the corresponding instruction in the iCache 21, so that the BTAC lookup processing starts one or more cycles before the look-up of the corresponding branch instruction in the iCache 21, to compensate for any latency in retrieving a target address from the BTAC 27.

The offset implemented at 29 can be expressed in terms of time, expressed as one or more clock or processing cycles, expressed as an address numbering offset, or the like. An example is discussed below in which the offset identifies a fetch address somewhat ahead (increment) in time or in the instruction sequence, when compared to the fetch address used for the instruction fetch from the iCache. An alternative example writes the branch target address into the BTAC, with the appropriate offset (decrement), so that both fetches use the same address, but the BTAC fetch still leads the iCache fetch by the desired offset amount. In either example, if there is a branch target address in the BTAC 27, that branch address is applied to the logic of the Fetch stage, so as to begin to fetch the target instruction immediately following the branch instruction.

For a branch instruction that has not previously been copied to iCache 21, the BTAC 27 will not include a target address for the branch operation. There may be some situations in which the BTAC 27 will not include the target address, even though the iCache 21 includes the branch instruction, for example, because the processing has not yet taken the particular branch. In any such case where the target branch address is not included in the BTAC 27, a portion 31 of the instruction decode logic will calculate the target address, during processing of the branch instruction in the decode stage 13.

The processor could write the calculated target address to the BTAC 27 when calculated as part of the decode logic. However, not all branches are taken, for example, because the condition for a conditional branch instruction is not met. The logic of the execution stage 17 will include logic 33 to determine if the branch should be taken. If so, then the processing will include a write operation (logic shown at 35), to write the calculated branch target address into the BTAC 27. Although not separately shown, the result of an execution to take a particular branch will involve providing the target address to the Fetch stage logic, to fetch the target instruction for subsequent processing through the pipeline.

A normal operation or an operation where the BTAC access consumes a single fetch cycle uses the same address to concurrently access both the iCache 21 and the BTAC 27 during an instruction fetch. To further improve performance, where the BTAC access requires multiple cycles, the BTAC fetch operation fetches ahead of the instruction fetched in the iCache, based on the Offset implemented at 29 in FIG. 1.

The number of cycles required for the BTAC fetch determines the number of cycles or length desired for the forward looking offset. If a BTAC access takes two cycles, then the BTAC fetch should look one fetch cycle ahead of the iCache fetch. If a BTAC access takes three cycles, then the BTAC fetch should look two fetch cycles ahead of the iCache fetch, and so on. As noted, if a BTAC access requires only one fetch cycle, an offset may not be needed.

In one example, the address used for the BTAC fetch leads that used in iCache fetch, by an offset intended to compensate for the delay in fetching from the BTAC in the case of a hit. If implemented during a fetch, this entails an increment in the fetch address. Alternatively, when writing to the caches, the BTAC write address may lead the address used for storage of the branch instruction in the iCache, by the appropriate offset amount. Since it is implemented on the write operation but is intended to cause a read or fetch before the corresponding iCache fetch, the write operation decrements the address used to write the target address into the BTAC.

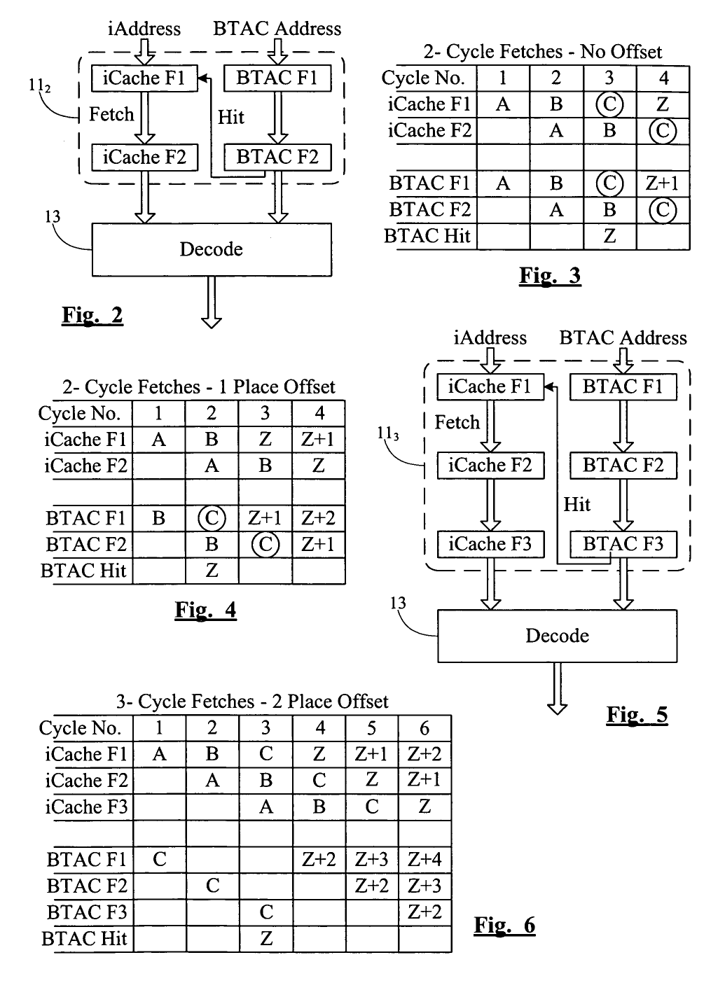

To fully appreciate the forward looking operations, it may be helpful to consider some examples. With respect to FIGS. 2 to 4, assume that the BTAC fetch requires two processing cycles. Although the cycles for the two fetches may not always be the same, for ease of discussion, the instruction fetch from the iCache similarly requires two cycles in this example. Essentially, the Fetch stage 11₂ may be considered as being pipelined. Although the fetch stages may be combined, for this example, assume that each type of fetch is performed in two separate pipeline stages, and the iCache fetch pipeline runs in parallel with the stages forming the BTAC fetch pipeline. Each of the pipelines therefore consists of two stages.

Each stage of the fetch pipeline 11₂ performs a different function necessary in the overall processing of each program instruction. The first stage related to the instruction fetch processing (iCache F1) receives the instruction address (iAddress), performs its functional processing to begin fetching of the addressed instruction and passes its results to the second stage related to the instruction fetch processing (iCache F2). During the next cycle, iCache F1 receives another instruction address, while the iCache F2 completes fetch processing with regard to the first address and passes the results, that is to say the fetched instruction, to the Decode stage 13.

In parallel, the first stage related to the target address (BTAC) fetch processing (BTAC F1) receives the BTAC fetch address, performs its functional processing to begin a fetch from the BTAC and passes its results to the second stage related to the instruction fetch processing (BTAC F2). During the next cycle, the BTAC F1 stage receives another instruction address, while the iCache F2 completes fetch processing with regard to the first address and passes the results if any to the Decode stage 13. If the BTAC processing fetches a branch target address from the BTAC 27, the second BTAC pipeline stage (BTAC F2) provides the hit results to the first stage related to the instruction fetch processing (iCache F1) so that the next new instruction fetch will utilize the appropriate target branch address from the cache 27.

FIG. 3 is a table or timing diagram representative of the cycle timing and associated processing in a 2-cycle fetch stage, such as stage 11₂ shown in FIG. 2. The alphabetic characters in the table represent instruction addresses. For example, A, B and C are sequential address, as they might be processed at the start of an application program. Z represents a target address, that is to say the next instruction to be processed upon processing of a taken branch instruction.

In the example of FIG. 3, for discussion purposes, it is assumed that there is no offset between the processing for the iCache fetch stages and the BTAC fetch stages. Hence, during processing cycle 1, the iCache F1 stage performs its fetch related processing with regard to first address A, and the BTAC F1 stage performs its fetch related processing with regard to first address A. The two F1 stages pass the respective results to the corresponding F2 stages, for processing in the second cycle. During the second cycle the iCache F1 stage performs its fetch related processing with regard to second address B, and the BTAC F1 stage performs its fetch related processing with regard to second address B. The F2 stages both complete processing with regard to second address B at the end of the third cycle. However, during that third cycle, the F1 stages are both processing a third sequential instruction C.

Now assume that the second instruction B is a branch instruction, for which the BTAC 27 stores a target branch address Z. The second stage of the BTAC pipeline (BTAC F2) finds the hit and provides the target address Z in the third cycle. The target address Z becomes available and is processed as the instruction fetch address, in the iCache F1 stage, in the next processing cycle, that is to say in the fourth cycle.

As shown however, both F1 stages began processing a sequential address in the third cycle (as represented by the circled address C). Such processing is extraneous and any results must be cleared from the pipeline. Similar processing may occur and need to be cleared from the F2 stages in the next (fourth) processing cycle (again by the circled address C). The unnecessary processing of the third sequential address is a waste of processing time, and the need to clear the stages of any related data incurs a delay and reduces performance.

FIG. 4 is a table or timing diagram representative of the cycle timing and associated processing in a 2-cycle fetch stage, such as the stage 11₂ shown in FIG. 2, wherein the fetch stage 11₂ implements forward looking offset of the BTAC fetch with respect to the iCache fetch. The table of FIG. 4 is similar to that of FIG. 3, in that both use the same notation. The offset represented in FIG. 4, however, eliminates the wasted iCache fetch processing cycles.

In the example of FIG. 4, the offset between the processing for the iCache fetch stages and the BTAC fetch stages corresponds to one instruction address. For discussion purposes, the offset is represented by a fetch address increment. As noted above, the same results may be achieved by a decremental offset of the BTAC write address.

During processing cycle 1, the iCache F1 stage performs its fetch related processing with regard to first address A, however, the BTAC F1 stage performs its fetch related processing with regard to second address B. The two F1 stages pass the respective results to the corresponding F2 stages for processing related to A and B respectively in the second cycle. During the second cycle the iCache F1 stage performs its fetch related processing with regard to second address B, and the BTAC F1 stage performs its fetch related processing with regard to third address C.

The BTAC F2 stage completes its processing with regard to second address B at the end of the second cycle. Since the second instruction B is a branch instruction, for which the BTAC 27 stores a target branch address Z, in this example, the BTAC F2 stage of the BTAC pipeline finds the hit and provides the target address Z in the second cycle. The target address Z becomes available and is processed as the instruction fetch address, in the iCache F1 stage, in the next processing cycle, that is to say in the third cycle. Consequently, the iCache pipeline stages can process the instruction corresponding to the target branch address immediately, without unduly beginning to process a next sequential address.

There may still be some unnecessary processing of the next sequential address, in the BTAC pipeline stages, (as represented by the circled address C). However, because of the low frequency of occurrence of branch instructions, particularly back to back branch taken instructions, clearing data for such unnecessary processing in the BTAC pipeline has relatively little impact on overall processor performance.

It should be apparent from an examination of the simple example in FIGS. 2 and 4 that, at start-up, the instructions fetched from the iCache 21 in the initial cycle(s) corresponding to the offset do not have a corresponding BTAC fetch. Typically, the first instruction is not a branch, so this is not problematic. However, as the number of cycles of the BTAC fetch increases, and the attendant offset increases, it may be advisable to avoid branch operations in the first series of instructions before first passage of the BTAC offset.

FIGS. 5 and 6, shown pipeline processing and associated timing, for a processor in which BTAC fetch operations entail three processing cycles. Although the iCache and BTAC cycles may not always be the same, for ease of discussion, the instruction fetch from the iCache similarly requires three cycles in this example. Essentially, the Fetch stage 11₃ may be considered as being pipelined. Although the fetch stages may be combined, for this example, assume that each type of fetch is performed in two separate pipeline stages, and the iCache fetch pipeline runs in parallel with the stages forming the BTAC fetch pipeline. Each of the pipelines therefore consists of three stages.

Each stage of the fetch pipeline 11₃ performs a different function necessary in the overall processing of each program instruction. The first stage related to the instruction fetch processing (iCache F1) receives the instruction address (iAddress), performs its functional processing to begin fetching of the addressed instruction and passes its results to the second stage related to the instruction fetch processing (iCache F2). During the next cycle, the iCache F1 stage receives another instruction address, while the iCache F2 stage performs its fetch processing with regard to the first address and passes the results to the next stage. During the third cycle, the iCache F1 stage receives another instruction address, while the iCache F2 stage performs its fetch processing with regard to the second address, and the third stage related to the instruction fetch processing (iCache F3) completes processing with regard to the first instruction address and passes the results to the Decode stage 13.

In parallel, the first stage related to the target address (BTAC) fetch processing (BTAC F1) receives the BTAC fetch address, performs its functional processing and passes its results to the second stage related to the instruction fetch processing (BTAC F2). During the next cycle, the stage BTAC F1 receives another instruction address, while the BTAC F2 stage performs its fetch processing with regard to the first address and passes the results to the next stage. During the third cycle, BTAC F1 receives yet another instruction address, while the BTAC F2 performs its fetch processing with regard to the second BTAC address, and the third stage related to the instruction fetch processing (BTAC F3) completes processing with regard to the first BTAC address and passes the results to the Decode stage 13.

FIG. 6 is a table or timing diagram representative of the cycle timing and associated processing in a 3-cycle fetch stage, such as that shown in FIG. 5, wherein the fetch stage pipeline 11₃ implements a forward looking offset of the BTAC fetch with respect to the iCache fetch, corresponding to two addresses. The table of FIG. 6 is similar to that of FIG. 4, in that it uses a similar notation. In this 3-cycle example, for convenience, assume that the third sequential instruction C is a branch instruction for which a target address is already stored in the BTAC 27.

In the example of FIG. 6, the offset between the processing for the iCache fetch stages and the BTAC fetch stages corresponds to two instruction addresses. For discussion purposes, the offset is represented by a fetch address increment. As noted above, the same results may be achieved by a decremental offset of the BTAC write address.

During processing cycle 1, the iCache F1 stage performs its fetch related processing with regard to first address A, however, the BTAC F1 stage performs its fetch related processing with regard to first address C. The two F1 stages pass the respective results to the corresponding F2 stages for processing with respect to A and C respectively in the second cycle. During the second cycle the iCache F1 stage performs its fetch related processing with regard to second address B, and the iCache F2 stage performs its fetch related processing with regard to first address A. During that same cycle, the BTAC F2 stage performs its fetch related processing with regard the address C.

In the third processing cycle, the iCache F1 stage processes third address C, the iCache F2 stage performs its fetch related processing with regard to address B, and the iCache F3 stage performs its fetch related processing with regard to address A. At the same time, in the BTAC pipeline, the BTAC F3 stage is completing the processing with regard to the address C. In this example, such processing produces a hit and the BTAC fetch fetches the target address Z (bottom line of the table).

Since instruction C is a branch instruction, for which the BTAC 27 stores a target branch address Z, the BTAC F3 stage of the BTAC pipeline finds the hit and provides the target address Z in the third cycle. The target address Z becomes available and is processed as the instruction fetch address, in the iCache F1 stage, in the next processing cycle, that is to say in the fourth cycle of our example. Consequently, the iCache pipeline stages can process the instruction corresponding to the target branch address immediately, without unduly beginning to process a next sequential address.

It should be noted that the forward looking BTAC fetch can be implemented in any pipeline processor having an iCache and BTAC. The Fetch stage need not be pipelined, or if pipelined, the Fetch stage need not necessarily be pipelined in the manner shown in the examples of FIGS. 2 and 5. The advantages of the offset to enable a forward looking BTAC fetch may be implemented in any processor in which the fetch operation requires two or more processing cycles.

In the examples, the processing cycle in which the Fetch stage begins the iCache fetch trails the corresponding BTAC fetch (or the BTAC fetch leads the iCache fetch) by one or more processing cycles defined by the offset, that is to say one fewer processing cycles than required to perform a BTAC fetch. For example, in FIG. 4, the iCache F1 stage begins the fetch of the branch instruction B in cycle 2, one cycle after the corresponding start of the fetch for the B target address by the BTAC F1 stage. In that first example, the BTAC fetch requires two cycles. Similarly, in FIG. 6, the iCache F1 stage begins the fetch of the branch instruction C in cycle 3, two cycles after the corresponding start of the fetch for the C target address by the BTAC F1 stage. In the example of FIGS. 5 and 6, the BTAC fetch requires three processing cycles. In each case, there is no unnecessary intermediate processing in the iCache fetch processing.

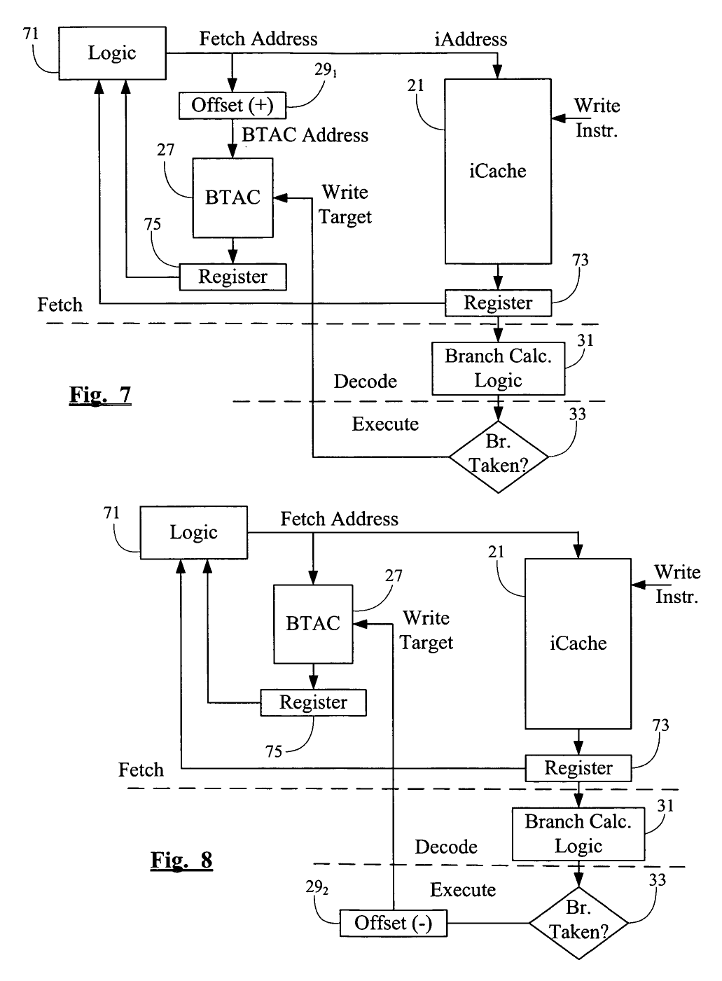

In the examples of FIGS. 2-6 discussed above, it was assumed that the offset involved an address for the BTAC fetch that was ahead of or leading the address used for the iCache fetch. To implement such an operation during fetch processing, the fetch logic will implement an address increment. Essentially, when the Fetch stage 11 receives an address for the instruction fetch, it uses that address as the iCache instruction address, but the logic increments that address to generate the address for the BTAC fetch. FIG. 7 is a functional block diagram of elements involved in such a fetch operation, involving an incrementing of the fetch address to obtain the address for the BTAC fetch. For ease of discussion, other elements of the pipeline have been omitted.

As shown, logic 71 in the Fetch stage provides a fetch address for use in accessing both the iCache 21 and the BTAC 27. The fetch address from the logic 71 is used directly as the address for accessing the iCache. In normal processing, the Fetch stage will go through two or more processing cycles to obtain the corresponding instruction from the iCache 21. The instruction from the iCache 21 is loaded into a register 73 and/or provided to the logic 71, for transfer to the Decode stage. As noted earlier, a portion 31 of the instruction decode logic will calculate the target address, during processing of the instruction in the decode stage 13; and the logic of the execution stage 17 will include logic 33 to determine if the branch should be taken. If so, then the processing will include a write operation (logic shown at 35 in FIG. 1), to write the calculated branch target address into the BTAC 27. In this example, the write operation is not modified.

However, the Fetch stage includes logic circuitry 29₁ (included in or associated with fetch stage logic 71) for incrementing the fetch address by the appropriate offset amount to generate the BTAC fetch address. In the 2-cycle fetch example of FIGS. 2 and 4, the circuitry 29₁ would increment the fetch address by one address value, so that the BTAC fetch would lead the iCache fetch by one cycle. In the 3-cycle fetch example of FIGS. 5 and 6, the circuitry 29₁ would increment the fetch address by two address values, so that the BTAC fetch would lead the iCache fetch by two cycles. In this way, the Fetch stage will go through two or more processing cycles to determine if there is a BTAC hit corresponding to the appropriate future instruction, and if so, retrieve the cached branch target address from the BTAC 27. The target address is loaded into a register 75 and provided to the logic 71. The logic 71 receives the branch target address sufficiently early to use that address as the next fetch address, in the next fetch processing cycle (see e.g. FIGS. 4 and 6). Although the path is not shown for convenience, the resulting target address also typically is transferred to the Decode stage with the corresponding branch instruction, to facilitate processing of the branch instruction further down the pipeline.

As an alternative to incrementing the address during the fetch operation, yet provide the desired forward looking BTAC fetch, it is also possible to modify the BTAC address of the branch target data when writing the data to the BTAC 27. If the associated instruction address is decremented when that address and the branch target address are written into the memory, the subsequent fetch from the BTAC based on current instruction address will lead that of the fetch of the branch instruction from the iCache. If the address decrement is appropriate, i.e. an address offset one less than the number of cycles required for a BTAC fetch, then the fetching of the instructions from the iCache 21 and any associated target addresses from the BTAC 27 will be exactly the same as in the earlier examples. In practice, it is often easier to implement the offset by modifying the write address when there is a branch taken during execution, rather than incrementing the fetch address every time during fetch operations.

FIG. 8 is a functional block diagram of elements involved in such a fetch operation, involving decrementing of the address of the target data when writing the calculated branch target the BTAC. For ease of discussion, other elements of the pipeline have been omitted. As shown, logic 71 in the Fetch stage provides a fetch address for use in accessing both the iCache 21 and the BTAC 27. In this example, both fetches use the same address, that is to say, both to fetch an instruction from the iCache 21 and to access the BTAC 27.

The Fetch stage will go through two or more processing cycles to obtain the corresponding instruction from the iCache 21. The instruction from the iCache 21 is loaded into a register 73 and/or provided to the logic 71, for transfer to the Decode stage. As noted earlier, a portion 31 of the instruction decode logic will calculate the target address, during processing of the instruction in the decode stage 13; and the logic of the execution stage 17 will include logic 33 to determine if the branch should be taken. If so, then the processing will include a write operation, to write the calculated branch target address into the BTAC 27.

In this example, the write operation is modified. Specifically, the write logic in the Execute stage includes decremental (−) Offset logic circuit 29₂. Normally the write address used to write the target address data to the BTAC 27 is the address of the branch instruction that generated the branch address. In the example of FIG. 8, however, the circuit 29₂ decrements that address by the appropriate offset amount. For a pipeline processor implementing a 2-cycle fetch, the circuit 29₂ would decrement the write address by one address value. For a processor implementing a 3-cycle fetch, the circuit 29₂ would decrement the write address by two addresses.

Now consider again the fetch operation. When the logic 71 generates the fetch address, that address points to a current desired instruction in the iCache 21. However, because of the decrement the write address for writing target data into the BTAC 27, the address used in the fetch actually corresponds to a later instruction address, determined by the amount of the offset. If the offset is one address value, the fetch address actually points to a potential BTAC hit for the next instruction to be pulled from the iCache 21. Similarly, if the offset is two addresses, the fetch address actually points to a potential BTAC hit for two instructions ahead of that currently being pulled from the iCache 21.

In this way, the Fetch stage will go through two or more processing cycles to determine if there is a BTAC hit corresponding to the appropriate future instruction, and if so, retrieve the cached branch target address from the BTAC 27. The target address is loaded into a register 75 and provided to the logic 71. The logic 71 receives the branch target address sufficiently early to use that address as the next fetch address, in the next fetch processing cycle after it initiates the iCache fetch for the corresponding branch instruction (see e.g. FIGS. 4 and 6). Although the path is not shown for convenience, the resulting target address also typically is transferred to the Decode stage with the corresponding branch instruction, to facilitate processing of the branch instruction further down the pipeline.

Although the examples have addressed two and three cycle BTAC fetch processing, and the corresponding offsets, those skilled in the art will recognize that the teachings are readily adaptable to fetch processing in which the BTAC fetch involves a larger number of cycles. In each case, the optimum offset would be one less than the number of cycles in the BTAC fetch. However, at the start of the fetch sequence, some number of instructions corresponding to the offset should not include a branch instruction, to avoid skipping a BTAC hit. If a branch instruction is included earlier, the first run of the program would process the branch instruction as one for which there is no BTAC hit (branch not previously taken) and the program would run in the normal manner, but without the performance improvement that would otherwise be provided by detecting the BTAC hit.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method of fetching instructions for use in a pipeline processor, comprising:
fetching instructions from an instruction cache;
during each fetching of an instruction, concurrently accessing a branch target address cache (BTAC) to determine if the BTAC stores a branch target address, wherein each access of the BTAC comprises at least two processing cycles; and
offsetting the accessing operations by a predetermined amount relative to the fetching operations to begin an access of the BTAC in relation to a branch instruction at least one cycle before initiating a fetch of the branch instruction from the instruction cache.

2. The method of claim 1, wherein:
each fetching from the instruction cache comprises generating a fetch address for an instruction to be fetched;
the offsetting comprises incrementing each fetch address by the predetermined amount; and
each accessing of the BTAC comprises fetching from the BTAC using an incremented fetch address resulting from the offsetting.

3. The method of claim 1, wherein:
the offsetting comprises decrementing an address for the branch instruction and writing the branch target address and the decremented address to the BTAC;
the method further comprises, during each cycle generating a fetch address for an instruction to be fetched; and
a fetching and an accessing begun in each cycle both use the fetch address generated during the cycle.

4. The method of claim 1, wherein the predetermined amount of the offsetting is sufficient to enable fetching of a branch target address corresponding to the branch instruction from the BTAC for use in a subsequent instruction fetching beginning in a processing cycle immediately following a processing cycle in which the fetching of an instruction began fetching of the branch instruction

5. The method of claim 4, wherein the predetermined amount comprises an address difference between fetching from the instruction cache and accessing the BTAC equal to one less than the number of cycles in each access of the BTAC.

6. The method of claim 5, wherein:
each access of the BTAC consists of two processing cycles; and
the predetermined amount comprises an address difference between the fetching of instructions from the instruction cache and the accessing of the BTAC equal to one instruction address.

7. The method of claim 5, wherein:
each access of the BTAC consists of three processing cycles; and
the predetermined amount comprises an address difference between the fetching of instructions from the instruction cache and the accessing of the BTAC equal to two instruction addresses.

8. A method of fetching instructions for use in a pipeline processor, comprising:
starting a fetch of a first instruction from an instruction cache;
concurrent with the start of the fetch of the first instruction, initiating a fetch in a branch target address cache (BTAC) to fetch a target address corresponding a branch instruction which follows the first instruction,
starting a fetch of the branch instruction from the instruction cache;
following starting of the fetch of the branch instruction, using the target address corresponding the branch instruction to start a fetch of a target instruction from the instruction cache.

9. The method of claim 8, wherein the fetch in the BTAC requires two or more processing cycles.

10. The method of claim 9, wherein the initiating of the fetch in the BTAC precedes the starting of the fetch of the branch instruction from the instruction cache by one or more processing cycles.

11. The method of claim 10, wherein the one or more processing cycles by which the fetch in the BTAC precedes the starting of the fetch of the branch instruction from the instruction cache is one less that the two or more processing cycles required for the fetch in the BTAC.

12. The method of claim 8, wherein:
the fetch of the first instruction uses a fetch address; and
the fetch in the BTAC uses an address incremented with respect to the fetch address.

13. The method of claim 8, wherein:
the fetch of the first instruction uses a fetch address; and
the concurrent fetch in the BTAC uses the fetch address, the branch address having been written to the BTAC with a decremented address to correspond to the fetch address.

14. A method of fetching instructions for use in a pipeline processor, comprising:
in a first processing cycle, starting a fetch of a first instruction from an instruction cache;
in the first processing cycle, initiating a fetch in a branch target address cache (BTAC) to fetch a target address corresponding to a branch instruction which follows the first instruction by a predetermined amount,
in a second processing cycle, later than the first processing cycle, starting a fetch of the branch instruction from the instruction cache and completing the fetch of the target address from the BTAC;
in a third processing cycle, later than the second processing cycle, using the target address corresponding the branch instruction to start a fetch of a target instruction from the instruction cache.

15. The method of claim 14, wherein the second processing cycle follows the first processing cycle by a number of one or more processing cycles one less than a number of two or more processing cycles required to complete the fetch from the BTAC.

16. The method of claim 14, wherein the step of initiating a fetch in the BTAC comprises:
incrementing an instruction address used in the starting of the fetch of the first instruction from the instruction cache in the first processing cycle by the predetermined amount; and
using the incremented address to start the fetch in the BTAC to fetch the target address corresponding to the branch instruction.

17. The method of claim 16, wherein each increment is by a number of one or more addresses one less than a number of two or more processing cycles required to complete the fetch from the BTAC.

18. The method of claim 14, wherein:
the step of initiating the fetch in the BTAC in the first processing cycle comprises accessing the BTAC using an instruction address used in the starting of the fetch of the first instruction from the instruction cache in the first processing cycle; and
an address used to write the branch target address to the BTAC was previously decremented from an instruction address used to write the branch instruction to the instruction cache by the predetermined amount, so that the address of the target address in the BTAC corresponds to the instruction address used in the starting of the fetch of the first instruction from the instruction cache in the first processing cycle.

19. The method of claim 18, wherein the decrement is by a number of one or more addresses one less than a number of two or more processing cycles required to complete the fetch from the BTAC.

20. A processor, comprising:
an instruction cache for storing instructions;
a branch target address cache for storing a branch target address corresponding to one of the stored instructions which comprises a branch instruction;
a fetch stage for fetching instructions from the instruction cache and for fetching the branch target address from the branch target address cache;
at least one subsequent processing stage for performing one or more processing functions in accord with the fetched instructions; and
logic for offsetting the fetching from the branch target address cache ahead of the fetching of the instructions from the instruction cache by an amount related to a number of processing cycles required to complete each fetching from the branch target address cache.

21. The processor of claim 20, wherein the amount is a number one less than a number of processing cycles required to complete each fetching from the branch target address cache.

22. The processor of claim 20, wherein:
the logic comprises logic associated with the fetch stage for incrementing an address the fetch stage uses to fetch from the instruction cache; and
the fetch stage uses the incremented address for fetching from the branch target address cache.

23. The processor of claim 20, wherein:
the fetch stage concurrently uses an instruction address both for fetching from the instruction cache and for fetching from the branch target address cache; and
the logic comprises logic for decrementing an address of the branch instruction and using the decremented address to write the branch target address to the branch target address cache.

24. The processor of claim 23, wherein the logic for decrementing is associated with the at least one subsequent processing stage.

25. The processor of claim 20, wherein the fetch stage comprises a number of pipelined processing stages.

26. The processor of claim 25, wherein the number of processing cycles required to complete each fetching from the branch target address cache equals the number of pipelined processing stages.

27. The processor of claim of claim 20, wherein the at least one subsequent processing stage comprises:
an instruction decode stage;
a readout stage;
an instruction execute stage; and
a result write-back stage.

28. A pipeline processor, comprising:
a fetch stage for fetching instructions from an instruction cache wherein one of the instructions is a branch instruction, and for fetching a branch target address corresponding to the branch instruction from a branch target address cache;
at least one subsequent processing stage for performing one or more processing functions in accord with the fetched instructions; and
means for offsetting the fetching from the branch target address cache so as to lead the fetching of the instructions from the instruction cache, to compensate for a number of processing cycles required to complete each fetching from the branch target address cache.

29. The pipeline processor of claim 28, wherein the fetch stage comprises a number of pipelined processing stages.

30. The pipeline processor of claim of claim 28, wherein the at least one subsequent processing stage comprises:
an instruction decode stage;
a readout stage;
an instruction execute stage; and
a result write-back stage.
